(19) United States
(12) Patent Application Publication
(10) Pub. No.: US 2015/0379516 A1
(43) Pub. Date: Dec. 31, 2015

(54) Method and Apparatus for Performing Authentication Services

(71) Applicant: Moneygram International, Inc., Minneapolis, MN (US)

(72) Inventors: Eva Marie Yingst, Dallas, TX (US); Jeffrey S. Countryman, Bloomington, MN (US); Nicholas B. Lewis, Plymouth, MN (US); Vijaysenthil Veeriah, Hopkins, MN (US); Denise Brown, Maple Grove, MN (US)

(73) Assignee: Moneygram International, Inc., Minneapolis, MN (US)

(21) Appl. No.: 14/315,223

(22) Filed: Jun. 25, 2014

(51) Int. Cl. G06Q 20/40; G06Q 50/26

(52) U.S. Cl. CPC G06Q 20/4014; G06Q 20/405; G06Q 40/02; G06Q 20/40145; G06Q 50/26

(57) ABSTRACT

A method of authenticating information associated with a consumer in connection with a third party transaction is disclosed and includes receiving transaction information descriptive of a transaction initiated between a consumer and a third party. The method may include determining a type verification to be performed based on the transaction information, and receiving an input associated with authentication of information associated with the consumer. The authentication may be performed based on the type of verification indicated in the transaction information. The method may include generating verification information based on the input associated with the authentication of information associated with the consumer. The verification information may facilitate completion of the transaction

### TECHNICAL FIELD

The present application relates to systems and methods for authentication services, and more particularly to third party verification of a person's identify on behalf of a third party.

### BACKGROUND

Identity verification is a pre-requisite to completion of many types of in-person consumer transactions, such as verifying that a person attempting to withdraw funds from a bank account at a brick-and-mortar location of a banking entity is an owner or authorized user of the bank account. In such transactions, the identify verification is performed on-site (e.g., at the brick-and-mortar location where the transaction is taking place). However, in many settings, on-site identity verification is not possible, feasible, or practical. For example, an online entity (e.g., an online only bank) may not have a brick-and-mortar location that a consumer can visit to perform transactions. For such entities, authentication of consumer identities may not be reliable. As another example, an entity may have a brick-and-mortar location, but that location may be located disparate from a consumer, such as in a rural setting. Thus, visiting the brick-and-mortar location to perform identity verification may be inconvenient for the consumer.

### BRIEF SUMMARY

The present disclosure provides for systems, methods, and computer-readable storage devices configured to perform authentication of information associated with a consumer in connection with a transaction between the consumer and a third party. Information associated with the authentication of the information associated with the consumer may be provided to the third party to selectively facilitate completion of the transaction. For example, when the information associated with the consumer is authenticated successfully, the information provided to the third party may facilitate completion of the transaction, and when the information associated with the consumer is not authenticated successfully, the information provided to the third party may facilitate cancellation of the transaction. The exemplary systems, methods, and computer-readable storage devices described herein may increase the convenience of authentication information associated with consumers, and may increase consumer safety in connection with some transactions. Additionally, the exemplary systems, methods, and computer-readable storage devices described herein may reduce a likelihood of fraud in connection with some transactions.

In accordance with an exemplary aspect, a method includes receiving transaction information descriptive of a transaction initiated between a consumer and a third party. The method includes receiving an input associated with authentication of information associated with the consumer, and generating, based on the input associated with the authentication of information associated with the consumer, verification information to facilitate completion of the transaction.

In accordance with another exemplary aspect, an agent device includes a processor and a memory coupled to the processor. The memory stores instructions that, when executed by the processor, cause the processor to perform operations that include receiving transaction information descriptive of a transaction initiated between a consumer and a third party. The operations include receiving an input associated with authentication of information associated with the consumer, and generating, based on the input associated with the authentication of information associated with the consumer, verification information to facilitate completion of the transaction.

In accordance with yet another exemplary aspect, a computer-readable storage device stores instructions that, when executed by a processor, cause the processor to perform operations that include receiving transaction information descriptive of a transaction initiated between a consumer and a third party. The operations include receiving an input associated with authentication of information associated with the consumer, and generating, based on the input associated with the authentication of information associated with the consumer, verification information to facilitate completion of the transaction.

The foregoing has outlined rather broadly the features and technical advantages of the present invention in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of embodiments described herein, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present embodiments.

### BRIEF DESCRIPTION OF THE DRAWINGS

For a more complete understanding, reference is now made to the following descriptions taken in conjunction with the accompanying drawings, in which:

FIG. 1 is a block diagram of an exemplary system for authenticating information associated with a consumer in connection with a third party transaction;

FIG. 2 is a flow chart illustrating aspects of a first exemplary method of authenticating information associated with a consumer in connection with a third party transaction;

FIG. 3 is a flow chart illustrating aspects of a second exemplary method of authenticating information associated with a consumer in connection with a third party transaction; and

FIG. 4 is a flow chart illustrating aspects of a third exemplary method for authenticating information associated with a consumer in connection with a third party transaction.

### DETAILED DESCRIPTION

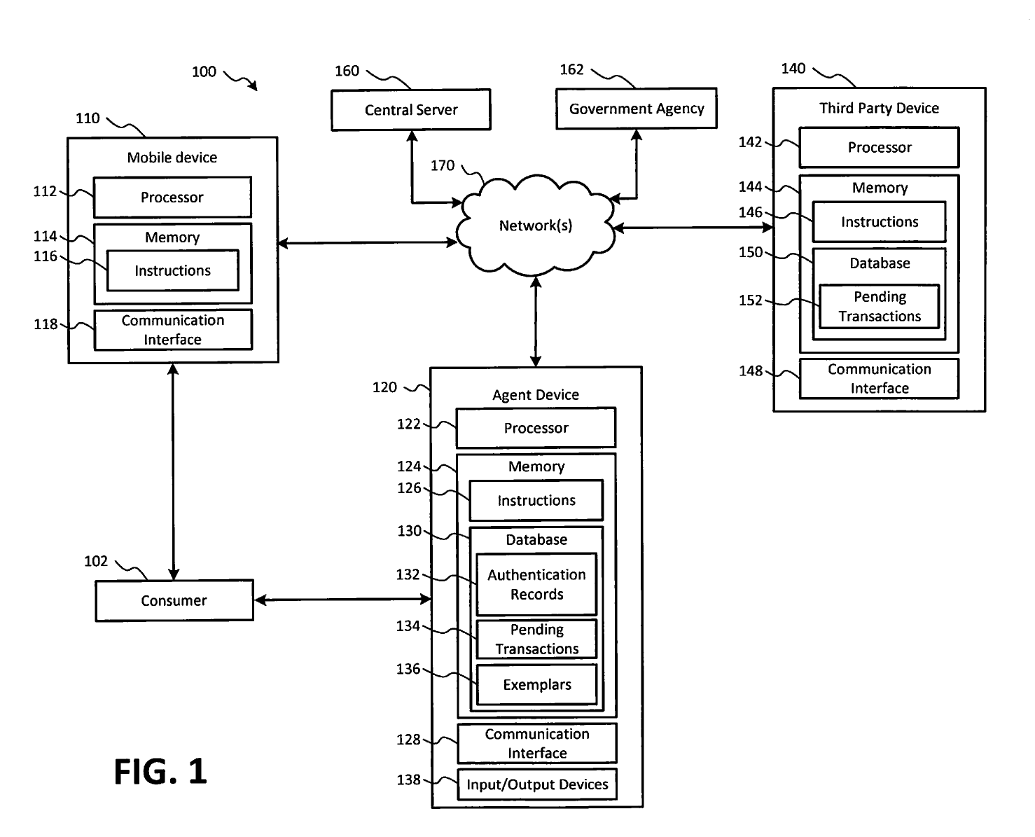

Referring to FIG. 1, a block diagram of an exemplary system for authenticating information associated with a consumer in connection with a third party transaction is shown as a system 100. In FIG. 1, a consumer 102, a mobile device 110, an agent device 120, a third party device 140, a central server 160, a government agency server 162, and a network(s) 170 are shown. The system 100 may facilitate authentication of information associated with the consumer 102 (e.g., a user of the mobile device 110) in connection with a transaction between the consumer 102 and a third party, as described in more detail below.

The mobile device 110 includes a processor 112, a memory 114, and a communication interface 118. The memory 114 may include read only memory (ROM) devices, random access memory (RAM) devices, one or more hard disk drives (HDDs), flash memory devices, solid state drives (SSDs), other devices configured to store data in a persistent or non-persistent state, or a combination of different memory devices. The memory 114 may store instructions 116 that, when executed by the processor 112, cause the processor 112 to perform operations described in connection with the mobile device 110 with reference to FIGS. 1-4.

The communication interface 118 may be configured to communicatively couple the mobile device 110 to one or more networks, such as a network 170, as shown in FIG. 1. The communication interface 118 may be configured to communicatively couple the mobile device 110 to the network 170 via a wired or wireless connection established according to one or more communication protocols or standards (e.g., an Ethernet protocol, a transmission control protocol/internet protocol (TCP/IP), an institute of electrical and electronics engineers (IEEE) 802.11 protocol, and an IEEE 802.16 protocol, a 3^{rd} generation (3G) protocol, a 4^{th} generation (4G)/long term evolution (LTE) protocol, etc.).

The network 170 may be a wired network, a wireless network, or may include a combination of wired and wireless networks. For example, the network 170 may be a local area network (LAN), a wide area network (WAN), a wireless WAN, a wireless LAN (WLAN), a metropolitan area network (MAN), a wireless MAN network, a cellular data network, a cellular voice network, the internet, etc. Additionally, the network 170 may include multiple networks operated by different entities. For example, the network 170 may include a first network (e.g., a payment processing network) operated by a first network operator (e.g., a financial card payment processing entity, a credit card company, a bank, an automatic clearing house (ACH) entity, another type of financial entity, etc.) and a second network (e.g., a LAN, WAN, WLAN, wireless WAN, etc.) operated by a second operator (e.g., a money transfer agent, an operator of a chain of grocery stores, a fueling station, an operator of a chain of fueling stations, etc.). The mobile device 110 may communicate with the agent device 120 and/or the third party device 140 via the connection to the network 170.

As shown in FIG. 1, the agent device 120 includes a processor 122, a memory 124, and a communication interface 128. The memory 124 may include ROM devices, RAM devices, one or more HDDs, flash memory devices, SSDs, other devices configured to store data in a persistent or non-persistent state, or a combination of different memory devices. The memory 124 may store instructions 126 that, when executed by the processor 122, cause the processor 122 to perform operations described in connection with the agent device 120 with reference to FIGS. 1-4. The communication interface 128 may be configured to communicatively couple the agent device 120 to one or more networks, such as the network 170, as shown in FIG. 1. The communication interface 128 may be configured to communicatively couple the agent device 120 to the network 170 via a wired or wireless connection established according to one or more communication protocols or standards (e.g., an Ethernet protocol, a TCP/IP protocol, IEEE 802.11 protocol, and an IEEE 802.16 protocol, a 3G protocol, a 4G/LTE protocol, etc.).

In an aspect, the agent device 120 may be a laptop computing device, a personal computing device, a tablet computing device, a point of sale (POS), a handheld POS, a smartphone, a mobile communication device, or any other electronic device operable to perform the operations of the agent device 120, as described with reference to FIGS. 1-4. The agent device 120 may include or may be coupled to one or more input/output (I/O) devices 138. The I/O devices 138 may include a money order printer, a signature pad, a camera, a pin pad module, a financial card reader, a biometric scanner, a receipt printer, another printing device, a barcode scanner, a metering device, a weight sensor, a check reader, a mouse, a keyboard, a touchscreen display device, a printer, a card scanner, a numeric keypad, a check reader, other types of input and output devices, or a combination thereof.

As shown in FIG. 1, the third party device 140 includes a processor 142, a memory 144, and a communication interface 148. The memory 144 may include ROM devices, RAM devices, one or more HDDs, flash memory devices, SSDs, other devices configured to store data in a persistent or non-persistent state, or a combination of different memory devices. The memory 144 may store instructions 146 that, when executed by the processor 142, cause the processor 142 to perform operations described in connection with the third party device 140 with reference to FIGS. 1-4. The communication interface 148 may be configured to communicatively couple the third party device 140 to one or more networks, such as the network 170, as shown in FIG. 1. The communication interface 148 may be configured to communicatively couple the third party device 140 to the network 170 via a wired or wireless connection established according to one or more communication protocols or standards (e.g., an Ethernet protocol, a TCP/IP protocol, IEEE 802.11 protocol, and an IEEE 802.16 protocol, a 3G protocol, a 4G/LTE protocol, etc.).

In an aspect, the third party device 140 may be a web server providing an online shopping website or service, a laptop computing device, a personal computing device, a tablet computing device, a POS, a handheld POS, a smartphone, a mobile communication device, or any other electronic device operable to perform the operations of the third party device 140, as described herein with reference to FIGS. 1-4. In an aspect, an online retailer may operate the third party device 140 to facilitate authentication of information associated with consumers, such as the consumer 102, that make purchases from the online retailer. In additional or alternative aspects, the third party may utilize the third party device 140 to outsource authentication of information associated with the consumers, such as the consumer 102, that make purchases from the online retailer (e.g., the third party device 140 is operated by an independent authentication service provider).

The third party device 140 may include or may be coupled to one or more peripheral devices (not shown in FIG. 1). For example, the one or more peripheral devices may include a money order printer, an identification capture device (e.g., a signature pad, a camera, a pin pad module, a financial card reader, a biometric scanner, etc.), a receipt printer, another printing device, a barcode scanner, a metering device, a weight sensor, a check reader, etc. The third party device 140 may process financial transactions (e.g., deposits to and withdrawals from accounts at a bank entity, wire transfers, account-to-account transfers between different accounts within the banking entity, account-to account transfers between an account of the banking entity and an account of another entity, processing of payments using gift cards, debit cards, and/or credit cards, etc.), or may be coupled to a peripheral device or network that processes and/or executes the banking and financial card transactions.

The agent device 120 may be one of many agent devices 120 located at a money transfer location operated by a money transfer entity that provides money transfer services between a sending party and a receiving party. The money transfer location may be a brick-and-mortar location, or may be located within a brick-and-mortar location of another entity, such as within a grocery store. In addition to providing money transfer services, the money transfer entity (e.g., an operator of the agent device 120) may provide authentication services on behalf of one or more third parties (e.g., an operator of the third party device 140). The authentication services may include authenticating the consumer 102 in connection with a third party transaction between the consumer 102 and an operator of the third party device 140. Authenticating the consumer 102 may include verifying the identity of the consumer 102, verifying one or more traits of the consumer 102 (e.g., age, birthdate, hair color, eye color, height, etc.), verifying a signature of the consumer 102, obtaining a biometric sample from the consumer 102, or other information, as described in detail below. The authentication of the consumer 102 by the money transfer entity may facilitate completion of the transaction between the consumer 102 and the third party. The money transfer entity may charge the third party, the operator of the third party device 140 (which may be the third party), the consumer 102, and/or another entity a fee for providing the authentication services in connection with the transaction. In some aspects, the fee may vary based on a type of authentication to be performed, a number of authentications to be performed, etc., as described in more detail below.

The system 100 facilitates authentication of information associated with the consumer 102 in connection with a transaction (e.g., a consumer-to-business transaction or a consumer to consumer transaction) between the consumer 102 and a third party. To illustrate, the third party may be an online retailer, and the consumer 102 may initiate the transaction with the third party by initiating a purchase from a website provided by the third party. In an aspect, the third party device 140 may function as, or may be communicatively coupled to a web server that provides the website. In an additional or alternative aspect, the third party device 140 may be distinct from the web server that provides the website, and may communicate with the web server to facilitate authentication of the information associated with the consumer 102 on behalf of the third party (e.g., the online retailer).

In response to initiating the transaction, the third party device 140 may generate transaction information. The transaction information may include information descriptive of a transaction initiated between the consumer 102 and the third party. For example, the transaction information may include a transaction identifier. In an aspect, the transaction identifier may be a code (e.g., a numeric code, an alphanumeric code, etc.). In an additional or alternative aspect, the transaction identifier may correspond to an identifier associated with an entry in a transaction log (e.g., a database of transactions between consumers and the third party). For example, a database 150 may be stored at the memory 144 of the third party device 140. In an additional or alternative aspect, the database 150 may be stored at a memory that is remote from the third party device 140, such as at a memory device of a storage area network, a database residing on a server that is distinct from the third party device 140, or may be stored in a distributed database (e.g., a database stored across geographically distributed locations and/or a database stored across a plurality of memory devices, such as in a redundant array of independent disks (RAID) configuration). The database 150 may include a log of pending transactions 152. The pending transactions 152 may correspond to transactions initiated between the third party and the consumer 102 (and between the third party and other consumers) that require information authentication, as described in more detail below. In an aspect, a first portion of the transaction identifier may include information or a code that identifies the third party and a second portion of the transaction identifier may include information or a code that identifies the transaction. In such instances, the first portion may be common to multiple transactions between consumers and single third party, and the second portion may be unique to each transaction. In an additional or alternative aspect, the third party device 140 may request a transaction identifier from the agent device 120 (or the central server 160). The agent device 120 may generate a unique transaction identifier for the transaction and transmit the transaction identifier to the third party device 140. The third party device 140 may associate the received transaction identifier with the transaction, and may generate transaction information that includes the received transaction identifier.

The transaction information may also include a type of verification to be performed. The type of verification may include an age verification, a signature verification, a photo verification, an account verification, a financial card verification, a proof of residency verification, a biometric verification, an employment verification, an unemployment verification, a probation check-in, a parole check-in, another type of verification, or a combination thereof. The type of verification to be performed may be specified by the third party. For example, when the third party is an online retailer, and the transaction is a purchase of a product from the online retailer, the purchase of the product may be restricted to consumers having an age that satisfies a threshold age. Thus, for purchases of products restricted to consumers having an age that satisfies the threshold age, the third party may specify an age verification (e.g., requesting authentication of whether the consumer 102's age satisfies the threshold age). Products that may be restricted to consumers having an age that satisfies the threshold age may include alcoholic beverages, a tobacco product, a prescription medication, a firearm, ammunition, entertainment media (e.g., a movie, a video game, or music stored on a compact disc (CD), a digital video disc (DVD), a blu-ray disc), paid subscription websites, an electronic device, or a combination thereof. Additionally, different age restricted products may be associated with different threshold ages (e.g., a first threshold age for a first set of products, a second threshold age for a second set of products, etc.). The transaction information may indicate the threshold age.

The transaction information may include verification criteria for types of verification other than age verification. For example, a signature verification may include a digital copy of a document that the consumer 102 is to sign, an account verification may include account information (e.g., an account number, an address associated with an account, etc.) that may be used to authenticate the consumer 102 as an owner or authorized user of an account (e.g., a bank account); a financial card verification may include financial card information provided to the third party by the consumer 102; a proof of residency verification may include information that identifies a target place of residency (e.g., a city, a zip code, a school district, an appraisal district, etc.); a biometric verification may include information that indicates a type of biometric verification (e.g., a facial recognition sample, a fingerprint scan, a retina scan, a speech sample, a palm print, or a combination thereof) to be performed, and may include a known exemplar (e.g., a previously obtained biometric sample known to have been obtained from the consumer 102); an employment verification may include information indicating a previous or current employer and/or a list of documents (e.g., a paystub, a W-2, etc.) that may be provided as proof of employment; an unemployment verification may include information identifying documents (e.g., paystubs, W-2 forms, tax returns, a social security card, other documentation showing unemployment, etc.) that may be required by a government entity to establish eligibility for or renewal of an unemployment benefit provided by the government entity; and a probation check-in and/or a parole check-in may include a threshold date upon which the consumer 102 must appear to perform the probation check-in or a parole check-in, and may include additional instructions for actions that the consumer 102 is to take, such as visiting a drug testing facility.

The transaction information may include information provided (e.g., via the online retailer website) to the third party by the consumer 102. For example, upon initiating the transaction, the third party may request that the consumer 102 provide information, such as the consumer 102's name, mailing address, age, home address, place of employment, social security number, an employment authorization identifier, a driver's license number, a passport number, a date of birth, other information particular to the consumer 102 and the transaction between the third party and the consumer 102, or a combination thereof. In some aspects, the consumer 102 may provide inputs to the mobile device 110 to generate the information and may initiate transmission of the information to the third party device 140 via the network 170. For example, the consumer 102 may be using a web browser capability of the mobile device 110 to make a purchase from the website of the online retailer. The transaction information may be stored at the database 150 in association with the corresponding pending transaction 152.

During operation, the agent device 120 may receive the transaction information. In an aspect, the transaction information may be received (e.g., using the communication interface 128) at the agent device 120 from third party device 140 via the network 170. In an additional or alternative aspect, the transaction information may be received (e.g., using communication interface 128) at the agent device 120 from the mobile device 110 via the network 170. In yet another additional or alternative aspect, the transaction information may be received at the agent device 120 via an input provided using one or more of the I/O devices 138. For example, the third party device 140 may initiate transmission the transaction identifier (or a barcode) to the mobile device 110 or another electronic device associated with or accessible to the consumer 102, and the transaction identifier (or the barcode) may be provided to the agent device 120 to cause the agent device 120 to access the third party device 140 and retrieve the transaction information (e.g., from the corresponding pending transaction 152 stored at the database 150). The transaction identifier (or the barcode) may be transmitted to the mobile device 110 via an email, a short message service (SMS) message, a text message, by providing access to the transaction identifier (or the barcode) from a menu within a graphical user interface provided by the website of the third party, or another form of deliver. An employee of a money transfer entity operating the agent device 120 may receive the transaction information from the consumer 102 and may enter the transaction information to the agent device 120 using a keyboard, a touchscreen display device, a barcode scanner, or another one of the I/O devices 138.

In an aspect, the third party device 140 may provide the corresponding pending transaction 152 including the transaction information to the agent device 120 prior to, concurrently with, or subsequent to initiating transmission of the transaction identifier (or the barcode) to the mobile device 110 or the other electronic device associated with or accessible to the consumer 102. The agent device 120 may receive the corresponding pending transaction 152 and may store the pending transaction 152 as an entry, such as the pending transaction 134, in a database 130 at the memory 124. The database 130 may be stored at a memory that is remote from the agent device 120, such as at a memory device of a storage area network, a database residing on a server that is distinct from the agent device 120, or may be stored in a distributed database (e.g., a database stored across geographically distributed locations and/or a database stored across a plurality of memory devices, such as in a redundant array of independent disks (RAID) configuration). In some aspects, the database 130 and the database 150 may be a same database and may be stored at the memory 124 of the agent device 120, the memory 144 of the third party device 140, or a memory (not shown in FIG. 1) of the central server 160 or accessible to the central server 160.

In an additional or alternative aspect, the agent device 120 may retrieve the corresponding pending transaction 152 including the transaction information in response to an input indicating the transaction identifier. The input may be received at the agent device 120 using one or more of the I/O devices 138, as described above. The agent device 120 may retrieve the corresponding pending transaction 152 by accessing the database 150 of the third party device 140, or the agent device 120 may initiate transmission of a request to the third party device 140. The request may include the transaction identifier. In response to receiving the request from the agent device 120, the third party device 140 may retrieve the corresponding pending transaction 152 from the database 150 and may initiate transmission of the corresponding pending transaction 152 to the agent device 120. The exchange of information between the agent device 120 and the third party device 140 may be encrypted and/or may be performed using a private network, a virtual private network, etc.

In additional or alternative aspects, the information provided to the mobile device 110 or the other electronic device associated with or accessible to the consumer 102 may include a form that may be printed by the consumer 102 and then presented to the employee operating the agent device 120. The form may include at least a portion of the transaction information (e.g., the transaction identifier, the type of verification to be performed, and/or other information.). The form may be used to manually create entry corresponding to the pending transaction 134 at the database 130. The form may include a barcode or other information representative of the transaction identifier associated with the corresponding pending transaction 152 and the portion of the transaction information included on the form may be used to manually create the pending transaction 134 at the database 130 (e.g., if communication with the third party device 140 is not available). The entries of the database 130 and the database 150 may be periodically reconciled to synchronize the information stored at each of the respective databases.

The agent device 120 may determine a type verification to be performed based on the transaction information. As explained above, the type of verification to be performed may include an age verification, a signature verification, a photo verification, an account verification, a financial card verification, a proof of residency verification, a biometric verification, an employment verification, an unemployment verification, a probation check-in, a parole check-in, another type of verification, or a combination thereof. The agent device 120 may be configured to present information indicating the type of verification to be performed at a display device or another one of the I/O devices 138. The information may instruct the employee (e.g., the user of the agent device 120) with respect to the type of verification to be performed. Additionally, the information presented at the display device (or another one of the I/O devices 138) may include other information, such as the information (e.g., the consumer 102's name, address, employment information, financial card information, account information, etc.) provided to the third party by the consumer 102 during the initiation of the transaction. In an additional or alternative aspect, the agent device 120 may provide a prompt to the employee to indicate that documents need to be printed (e.g., when the type of verification to be performed is the signature verification using pen and paper) or digital documents to be presented to the consumer 102 for signature (e.g., when the type of verification to be performed is the signature verification an electronic signature). Other information may also be presented to the employee, such as an image of the consumer 102 (e.g., in the case of a probation or parole check-in), and such other information may or may not be presented to the consumer 102.

The employee may then perform the authentication or verification of the information associated with the consumer 102 based on the transaction information. The employee may use one or more of the I/O device 138 to perform at least a portion of the authentication/verification of the information, as described in more detail below. Alternatively or additionally, the employee may perform at least a portion of the authentication/verification of the information. The employee and/or one or more of the I/O devices 138 may provide an input associated with the authentication/verification of the information to the agent device 120. The input may be associated with the authentication/verification of the information (e.g., the consumer 102's identity, address, residency information, employment information, financial card information, etc.) associated with the consumer 102.

Based on the input associated with the authentication/verification of the information associated with the consumer 102, the agent device 120 may generate verification information. The verification information may facilitate completion of the transaction between the consumer 102 and the third party. For example, the verification information may include a verification code indicating a result of the verification. The result may be a pass/fail result where a first value of the verification code indicates that the information associated with the consumer 102 was successfully authenticated or verified, and where a second value of the verification code indicates that the information associated with the consumer 102 was not successfully authenticated or verified. The verification information may alternatively or additional include other data, such as at least one trait (e.g., information obtained from the identification card) of the consumer 102, a biometric sample obtained from the consumer 102 using one or more of the I/O devices 138, etc. The agent device 120 may store the verification information (e.g., the verification code and/or the other data) in a database accessible to the third party. For example, in FIG. 1, the database 130 includes authentication records 132. The authentication records 132 may include the verification information and may be associated with a corresponding one of the pending transactions 134 and/or a corresponding one of the pending transactions 152. The verification information stored in the authentication records 132 may be accessible using the transaction identifier received from the third party device 140. In an aspect, each of the authentication records 132 and the corresponding pending transactions 134 may be stored as a single entry in the database 130, and/or as a single entry in the database 150 (e.g., after a synchronization operation or after transmitting the verification information from the agent device 120 to the third party device 140).

The verification information may facilitate completion of the transaction between the consumer 102 and the third party. For example, when the third party is the online retailer and the transaction is the purchase of a product from a website provided by the online retailer, completion of the transaction may include processing payment information provided to the third party by the consumer 102, and initiating processing of the order (e.g., scheduling shipment of the product to the consumer 102, printing shipping labels, etc.). Additionally, performing authentication of the information associated with the consumer 102 may facilitate purchases of certain products, such as age restricted products, from online retailers while ensuring compliance with local, state, and federal regulations regarding the purchase of the products. For example, the input associated with the authentication of the information associated with the consumer 102 may indicate whether the consumer 102 has an age that satisfies the threshold age, and the agent device 120 may generate verification information that indicates the age of the consumer 102 satisfies the threshold age or does not satisfy the threshold age.

When the age of the consumer 102 satisfies the threshold age, the third party may complete the transaction. However, when the age of the consumer 102 does not satisfy the threshold age, the third party may cancel the transaction. In an aspect, the third party may refrain from processing payment information provided by the consumer until receiving the verification information. This may prevent the third party from incurring processing fees for processing payments using financial cards (e.g., credit cards and/or debit cards) until after the transaction has been authenticated/verified, and verification information indicating the consumer 102 and the third party are authorized to complete the transaction has been received (e.g., at the third party device 140). Enabling the sale of age restricted products by online retailers through providing authentication/verification using the agent device 120 may increase sales for the online retailers, and may provide a more convenient way for consumers to make purchases that would otherwise be unavailable (e.g., due to government regulations/restrictions) or inconvenient (e.g., for consumers in rural setting, or consumers located remote from a brick-and-mortar location selling the product offered by the online retailer). Furthermore, some online retailers may require third party authentication for non-age restricted transactions (e.g., transactions exceeding a threshold dollar amount). This may reduce a likelihood of, and a volume of instances where fraud (e.g., credit card fraud, etc.) is used to make purchases from online retailers.

As another example, when the third party is the online retailer and the transaction is the execution (e.g., signing) of a document (e.g., a contract, an application for employment, a loan application, a purchase agreement, an application for a financial card, an application for a bank account, an application for or renewal of a government benefit program, or combination thereof), completion of the transaction may include obtaining the signature (e.g., a pen and ink signature, an electronic signature, a photo signature, a biometric signature, or a combination thereof) from the consumer 102, and providing the executed document to the third party. As explained above, the transaction information may include the a copy of the document to be executed and the type of verification (e.g., the type of signature) may be specified (e.g., by the third party, by the third party device 140, or both) in the transaction information. For signature type verifications, the input provided to, or received at the agent device 120 may include an electronic signature obtained from the consumer using one of the I/O devices 138, such an electronic signature pad, or may include a scanned copy of the document signed using pen and ink. When a pen and ink signature is used, the employee using the agent device 120 may retain the original signed copy of the document and may mail the original signed copy of the document to an address specified (e.g., in the transaction information) by the third party. The consumer 102 may be provided with a hard copy (e.g., a paper copy, a carbon copy, etc.) or a soft copy (e.g., a scanned copy) of the signed original document. In an aspect, the copies of the original document may be provided to the consumer 102 and/or the third party device 140 as an attachment to an email message. The agent device 120 may store a copy of the signed original document in association with the corresponding pending transaction 134 and the corresponding authentication records 132. The third party device 140 may receive the verification information, which includes the indication of the results of the verification of the information associated with the consumer, from the agent device 120, and may store the verification information in association with the corresponding pending transaction 152 prior to completing the transaction.

In an aspect, agent device 120 may be configured to authenticate the signature obtained from the consumer 102 by comparing the obtained signature to an exemplar 136 of the consumer 102's signature. In an additional or alternative aspect, the employee using the agent device 120 may authenticate the signature by comparing the signature provided by the consumer 102 to the exemplar 136 of the consumer 102's signature. Alternatively or additionally, the signature may be authenticated by verifying the identity of the person signing the document, such as by comparing the consumer 102's appearance to an image on an identification card (e.g., a driver's license, a passport, etc.).

Other exemplary techniques for authenticating/verifying information associated with the consumer 102 to facilitate completion of a transaction are described below. It is noted that the examples provided herein are provided for purposes of illustration, rather than by way of limitation, and the methods, apparatuses, systems, computer-readable storage devices, and techniques for authenticating consumers using the agent device 120 may utilize other techniques to authenticate/verify information associated with consumers to facilitate completion of transactions.

When the type of verification to be performed is an age verification, the employee operating the agent device 120 may request that the consumer 102 provide a form of identification, such as an identification card. The form of identification (e.g., driver's license, passport, another government issued identification card, or other acceptable form of identification) may be specified in the transaction information, and the employee may be prompted to indicate which form of identification is to be used for the authentication of the consumer 102's age. In an aspect, the agent device 120 may enable an employee operating the agent device 120 to authenticate an identification card (e.g., a driver's license, a passport, etc.). For example, the peripheral devices may include a device configured to read stored on or printed on the identification card (e.g., in a magnetic stripe, in a radio frequency identification (RFID) device integrated with or affixed to the identification card, text recognition, etc.). The device may then authenticate the card by communicating the information obtained from the identification card to a government agency or an electronic device of the government agency, such as the government agency server 162. The government agency (or the device of the government agency) may then provide (e.g., via the network 170) information to the agent device 120 indicating the authenticity of the identification card presented by the consumer 102.

In an aspect, the information provided by the government agency (or the device of the government agency) may correspond to an input provided to the agent device 120, and the agent device 120 may generate verification information that indicates whether the information associated with the authentication/verification of the identification card was successful (e.g., was the identification card an authentic identification card issued by the government agency). In an additional or alternative aspect, the information provided by the government agency (or the device of the government agency) may be analyzed by the employee and the employee may provide the input to the agent device 120. When the input associated with the authentication of the identification card indicates that the identification card of the consumer 102 is not authentic, the verification information provided from the agent device 120 to the third party device 140 may cause cancellation of the transaction. When the verification of the authentication of the identification card indicates that the identification card of the consumer 102 is not authentic, the verification information provided from the agent device 120 to the third party device 140 may cause cancellation of the transaction. The verification information may indicate at least one trait of the consumer 102, and the at least one trait may be obtained or determined based on information obtained from the identification card.

Knowing that the identification card, which may include an image of the consumer 102, is authentic (e.g., a valid government issued identification card) may assist the employee in authenticating or verifying the identity of the consumer 102 and other information associated with the consumer 102 (e.g., whether the consumer 102 is the person named on a financial card used to provide payment information for the transaction, etc.) on behalf of the third party, and may increase the reliability of the authentication/verification of the information associated with the consumer 102. In an aspect, the agent device 120 may store the information provided to the agent device 120 by the government agency (or the device of the government agency) in association with the corresponding pending transaction 134 and the corresponding authentication records 132. In some aspects, the verification information associated with an identity verification may include a scanned copy of the identification card used to perform the authentication of the information (e.g., an identity, an age, etc.) of the consumer 102. The third party device 140 may receive the verification information, which includes the indication of the results of the verification of the information associated with the consumer 102, from the agent device 120, and may store the verification information in association with the corresponding pending transaction 152 prior to completing the transaction.

As described above, in an aspect, the agent device 120 may provide the verification information to the third party to complete the transaction (e.g., a purchase from an online retailer). Additionally or alternatively, the verification information (e.g., a verification code) may be provided to the consumer 102 (e.g., a printed receipt or as electronic information transmitted to the mobile device 110 or another electronic device of the consumer 102, such as an e-mail or text message). The consumer 102 may subsequently provide the verification information to the third party to complete the transaction (e.g., the purchase from the online retailer). For example, the consumer 102 may access a website provided by the third party (which may be provided by or communicatively coupled to the third party device 140) and may enter the verification information (e.g., the verification code) received from the agent device 120. In response to receiving the verification information, the third party device 140 may then retrieve or access the authentication record 132 corresponding to the verification information using the verification code.

In an additional or alternative aspect, the verification information may include an image of the consumer 102. For example, when the verification information may include an image of the consumer 102 included in an identification card, as described, and may include an image of the consumer 102 captured using one of the I/O devices 138, such as a digital camera. Capturing a photo of the consumer 102 in addition to capturing the image of the consumer 102 from the identification card may further assure the third party, and any relevant regulatory authorities that may be interested in the transaction, that the information associated with the consumer 102 that initiated the transaction was authenticated correctly. This may include authenticating that an identification card provided by the consumer 102 during the authentication using the agent device 120 indicated a name that matched a name provided on a financial card used in connection with the transaction, or that the name of the consumer 102, as indicated on the identification card, matches a name provided by the consumer 102 in connection with another transaction, such as an application for employment or government benefit/assistance programs, or for other purposes and transactions.

Additionally or alternatively, the transaction may be a recurring transaction between the consumer 102 and the third party. For example, the third party may be a government entity, and the transaction may be associated with a periodic probation check-in, a periodic parole check-in, a periodic unemployment verification, an application for a government benefit or assistance program (e.g., food stamps, a women infants and children (WIC) program, etc.), a renewal of a government benefit or assistance program, an application for a government issued identification card, an application for a government issued license, an application to register to vote, or a combination thereof. In such instances, the verification information may indicate an eligibility of the consumer 102 to receive benefits under the government benefit or assistance program or to receive the government issued identification card or license, etc. Additionally, the verification information may indicate a location where the authentication took place, such as for transactions associated with probation or parole check-ins, which may require the consumer 102 to be present within a particular geographic area during the check-in. Furthermore, the agent device 120 may provide additional instructions that are to be provided to the consumer in connection with the transaction. For example, the additional instructions may direct the consumer 102 to visit a drug treatment center or testing facility following the check-in and may further specify a time window in which the consumer 102 is to complete the visit.

In an additional or alternative aspect, the third party may be a banking entity or other financial entity (e.g., credit card company), and the transaction may be associated with a deposit into an account at the banking entity from a remote location (e.g., the money transfer location), a withdrawal from the account at the banking entity from the remote location (e.g., the money transfer location), an application to open a bank account, a loan application, an application to open a credit card, or a combination thereof. In this aspect, the transaction information may include information descriptive of the account of the consumer 102, a document (e.g., an application, a withdrawal slip, a deposit slip, etc.), and the verification information may include a copy of the deposit or withdrawal slip and a copy of a receipt provided in connection with the withdrawal or the deposit, or may include an electronic copy of the completed application.

In another additional or alternative aspect, the third party may be an insurance provider and the transaction may be associated with an application for insurance (e.g., home owners' insurance, life insurance, automobile insurance, etc.), filing of an insurance claim, modification of a beneficiary designated in connection with an insurance policy, etc. In this aspect, the transaction information may include an electronic copy of the completed application and may request other documentation (e.g., a work authorization number, a copy of the consumer 102's social security card, a copy of the consumer 102's driver's license, etc.). Additionally, the transaction information may include instructions directing the consumer 102 to visit a health care provider (e.g., for a health screening, etc.). The verification information may include an electronic copy of the completed application, a scanned image of an identification card, a scanned image of a social security card, or other information requested by the insurance provider.

In another additional or alternative aspect, the third party may be an employer and the transaction may be associated with an application for employment. In this aspect, the transaction information may include an electronic copy of the completed application and may request other documentation (e.g., a work authorization number, a copy of the consumer 102's social security card, a copy of the consumer 102's driver's license, etc.), and the verification information may include an electronic copy of the completed application, a scanned image of an identification card, a scanned image of a social security card, or other information requested by the employer.

As explained above, when the type of authentication to be performed is a biometric verification, the verification may include obtaining information associated with a biometric sample from the consumer 102. The biometric sample may include a facial recognition sample, a fingerprint scan, a retina scan, a speech sample, a palm print, or a combination thereof. The I/O devices 138 may include a biometric scanning device(s) configured to obtain the biometric sample(s). In an aspect, the verification of the identity of the consumer 102 includes comparing a first biometric sample obtained from the consumer 102 in connection with the transaction to a second biometric sample previously obtained from the consumer 102. For example, the transaction information received (or retrieved) by the agent device 120 may include an exemplar (e.g., the second biometric sample) known to be from the consumer 102. As another example, the exemplar may be an exemplar 136 stored at, and obtained from the database 130. The exemplar 136 may correspond to the exemplar received from the third party, or may be a biometric sample obtained during a previous authentication/verification of information associated with the consumer 102. In an aspect, the biometric verification may generate verification information that indicates whether the first biometric sample matches the second biometric sample, or that indicates whether the first biometric sample matches the second biometric sample to within a pre-determined tolerance.

In another additional or alternative aspect, the transaction information may be included in a batch transaction processing request associated with a plurality of transactions initiated by one or more consumers. For each of the plurality of transactions, corresponding verification information may be provided in response to authenticating each of the transactions included in the batch transaction processing request to facilitate completion of each of the plurality of transactions. Transaction information for each of the plurality of transactions may be the same or different and may request the same or different types of authentication or combinations of types of authentication. The batch transaction processing request may include, for each of the plurality of transactions, information indicating a type of verification to be performed, and different transactions of the plurality of transactions may be associated with a same or different type of verification.

For example, first transaction information corresponding to a first transaction of the plurality of transactions may request a first type of authentication (e.g., an age verification), and second transaction information corresponding to a second transaction of the plurality of transactions may request a second type of authentication (e.g., an biometric verification). As another example, the first transaction information may request a first type of authentication (e.g., an age verification) and a second type of authentication (e.g., a photo verification or identity verification) in connection with the first transaction, and a second transaction of the plurality of transactions may request a third type of authentication (e.g., an employment verification). Other combinations of types of verifications may be employed, and may include more than or less than two types of verifications for each of the plurality of transactions associated with the batch transaction processing request.

Furthermore, the agent device 120 or the central server 160 may receive the batch processing request and may distribute the transaction information across various geographic locations. To illustrate, a money transfer entity or another entity providing third party authentication services using the agent device 120 may operate numerous locations across a city, a state, a country, or worldwide, and may distribute particular transaction information to relevant locations based on the transaction information included in the batch transaction processing request. For example a first transaction of the plurality of transactions included in the batch transaction processing request may be associated with a first location (e.g., a first city) and a second transaction of the plurality of transactions included in the batch transaction processing request may be associated with a second location (e.g., a second city). The agent device 120 or the central server 160 may provide the transaction information associated with the first transaction to an agent device located proximate to or at the first location and may provide other transaction information associated with the second transaction to an agent device located proximate to or at the second location.

Additionally or alternatively, the transaction information may be distributed according to capabilities of the respective agent devices. For example, a first agent device at a first location may provide a first set of authentication services, but may not provide a particular authentication service (e.g., a signature verification). Thus, transactions of the plurality of transactions including transaction information requesting the particular authentication service may be provided to agent devices at other locations (e.g., locations providing signature verification). In an aspect, the transaction information may be distributed based on both geographic information and capabilities of the respective agent devices within various geographic regions.

In an aspect, various geographic regions (e.g., cities, states, countries, etc.) may include a regional central server (not shown in FIG. 1) and the transaction information may be provided to an appropriate regional central server (e.g., a regional central server proximate to a location indicated in the transaction information). The regional central servers may include a database (e.g., a database 130) that is accessible to agent devices serving the respective regions. Other techniques for distribution of and communication of transaction information may be used in connection with the system 100 and the examples provided herein are merely illustrative of some techniques that may be used by the system 100 to distribute transaction information to disparate locations.

The transactions corresponding to the batch transaction processing request may be processed using one or more agent devices, such as the agent device 120 of FIG. 1, and may generate verification information for each of the plurality transactions. The verification information may be generated at different times based on an amount of time that elapses prior to consumers associated with the respective transactions visiting a respective location that includes an agent device. Thus, the transaction information and the verification information may be processed and generated and provided to the third party to facilitate completion of the transactions in any order.

In still another additional or alternative aspect, the third party may be another consumer, and the transaction may be associated with execution of a legal document, execution of a purchase agreement, a transfer of title, execution of a contract, etc. In this aspect, the transaction information may include information descriptive of the legal document, purchase agreement, the title, the contract, etc., and may include a copy of the respective document. The verification information may include an electronic copy of the executed (e.g., signed) document.

In a further additional or alternative aspect, the transaction may be a purchase from a web-based classifieds website or an auction website where individuals post items for sale to other individuals (e.g., a consumer-to-consumer transaction). The system 100 may facilitate authentication of information associated with the first consumer (e.g., a potential buyer of the product) on behalf of a second consumer (e.g., the seller of the product), may facilitate authentication of information associated with the second consumer 102 on behalf of the first consumer, or may facilitate authentication of information associated with multiple consumers (e.g., both a purchaser and a seller) in connection with a consumer-to-consumer transaction.

To illustrate, a seller may post an add on the web-based classified website or the auction website and may specify information associated with a potential buyer that is to be authenticated using the system 100. Furthermore, the potential buyer may request that the seller authenticate information using the system 100. The seller may decline the sale and forego the authentication, cancelling the transaction, or may accept the potential buyer's request and perform the requested authentication.

Upon one or both parties completing the authentication (depending on whether the potential buyer request authentication of information associated with the seller) of the specified information, the transaction may be completed. This may include the potential buyer meeting the seller to complete the transaction (e.g., a purchase or a trade), or the seller accepting payment information from the buyer and shipping a product to the potential buyer. Each of the respective parties may receive verification information associated with the authentication of the other party. If either party is dissatisfied with the verification information, additional authentication may be requested or the transaction may be canceled. In an aspect, the seller may perform a pre-authentication of information associated with the seller prior to a request from a potential buyer, such as when the seller frequently sells items using the web-based classified website or the auction website. In such instances, the agent device 120 may facilitate retrieval of the authentication information associated with the seller by the potential buyer. In an aspect, the seller must authorize the release of the authentication information to the potential buyer. Enabling authentication of sellers and buyers in consumer-to-consumer transactions may increase the safety of sellers and buyers that engage in such transactions (e.g., because the identity of the parties is verified and known prior to completing the transaction). Additionally, authentication may decrease a likelihood of fraud in such transactions.

Thus, the system 100, and in particular the agent device 120, may increase the reliability, safety, and convenience of many types of transactions (e.g., consumer-to-business transactions and/or consumer-to consumer transactions). Additionally, the system 100 may provide additional streams of revenue to an operator of the agent device 120 (e.g., through fees charged to one or more parties to a transaction in exchange for performing authentication of information). Furthermore, the system 100 may reduce a likelihood of fraud for transactions occurring from a remote location, such as a purchase from a website, and may assist business (e.g., online retailers) in complying with government imposed regulations with respect to the sale of particular products.

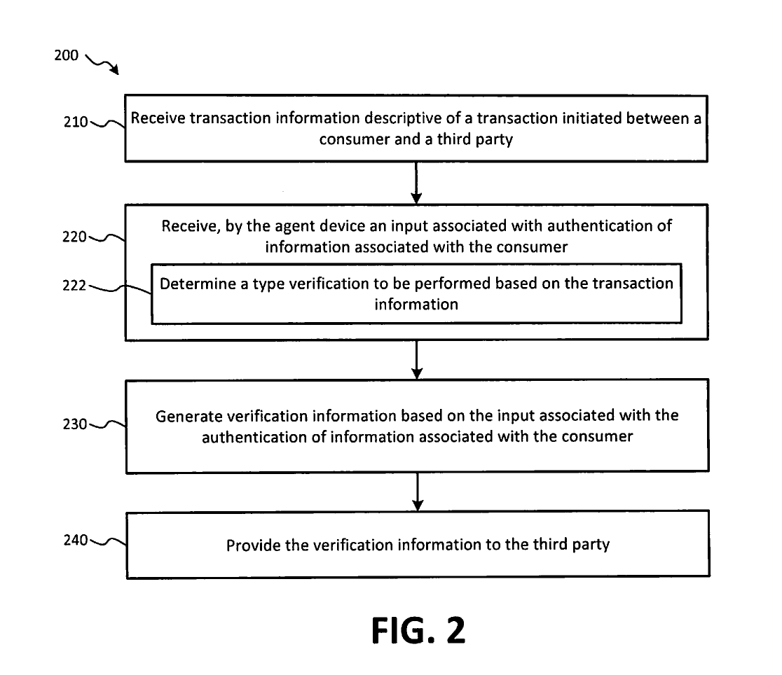

Referring to FIG. 2, a flow chart illustrating aspects of a first exemplary method of authenticating information associated with a consumer in connection with a third party transaction is shown as a method 200. The operations described in connection with the method 200 may be performed by the agent device 120 of FIG. 1, the central server 160 of FIG. 1, or any other device configured to perform at least some of the operations described with reference to FIG. 1 with respect to the agent device 120 and/or the central server 160.

As shown in FIG. 2, the method 200 includes, at 210, receiving transaction information descriptive of a transaction initiated between a consumer and a third party. The transaction information may be the transaction information described with reference to FIG. 1 and may be received at the agent device 120 of FIG. 1 and/or the central server 160 of FIG. 1 (e.g., via the network 170 of FIG. 1). The consumer may be the consumer 102 of FIG. 1 and the third party may be any one of the exemplary third parties described with reference to FIG. 1, including another consumer. The transaction may be a consumer-to-business transaction or the transaction may be a consumer-to-consumer transaction, as described with reference to FIG. 1.

At 220, the method 200 includes receiving an input associated with authentication of information associated with the consumer. The input may be received via one of the I/O devices 138 of FIG. 1. At 222, the method may include determining a type verification to be performed based on the transaction information, as described with reference to FIG. 1. The type of verification may indicate which of the I/O devices 138, if any, should be used to perform the authentication of the information associated with the consumer.

At 230, the method 200 includes generating verification information based on the input associated with the authentication of information associated with the consumer. The verification information may facilitate completion of the transaction. For example, the verification information may include information (e.g., a verification code) indicating whether the authentication of the information was successful or not, and the transaction may be completed or cancelled based on the verification information. In an aspect, the method 200 may include storing the verification information in a database (e.g., the database 130 of FIG. 1 and/or the database 150 of FIG. 1) accessible to the third party or a device of the third party, such as the third party device 140.

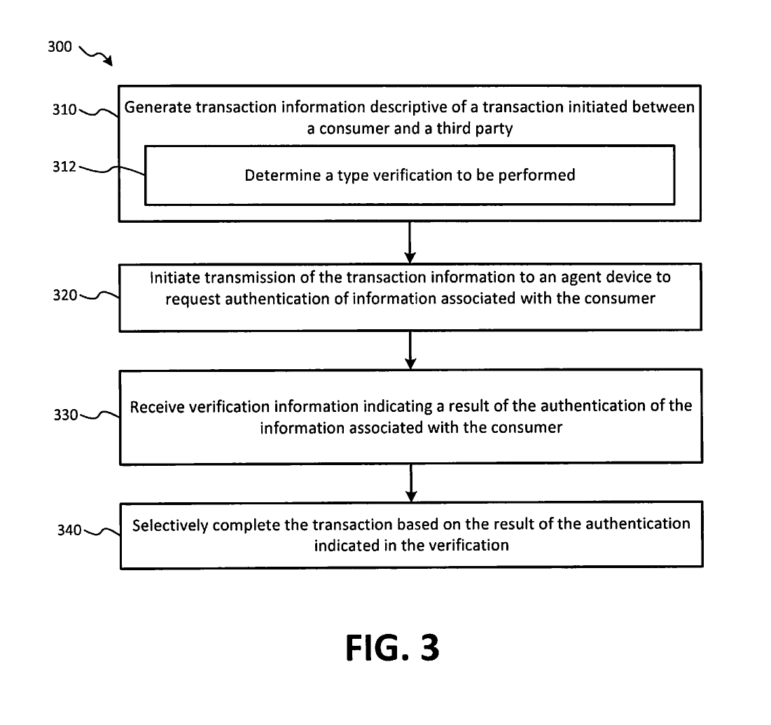

Referring to FIG. 3, a flow chart illustrating aspects of a second exemplary method of authenticating information associated with a consumer in connection with a third party transaction is shown as a method 300. The operations described in connection with the method 300 may be performed by the third party device 140 of FIG. 1, or any other device configured to perform at least some of the operations described with reference to FIG. 1 with respect to the third party device 140.

At 310, the method 300 includes generating transaction information descriptive of a transaction initiated between a consumer and a third party. The consumer may be the consumer 102 of FIG. 1 and the third party may be any one of the exemplary third parties described with reference to FIG. 1, including another consumer. The transaction may be a consumer-to-business transaction or the transaction may be a consumer-to-consumer transaction, as described with reference to FIG. 1. The transaction information may indicate a type of verification to be performed in connection with the authentication of the information associated with the consumer. For example, as shown at 312, the method 300 may include determining a type of verification to be performed to authenticate the information associated with the consumer, and the transaction information may be generated based, at least in part, on the determined type of verification. The type of verification may be include one or more of the types of verification described with reference to FIG. 1 or another type of verification.

At 320, the method 300 includes initiating transmission of the transaction information to an agent device to request authentication of the information associated with the consumer. The agent device may be the agent device 120 of FIG. 1, and the authentication may be performed, at least in party, using one or more the I/O devices 138 of FIG. 1. The agent device may generate verification information based on inputs associated with the authentication of information associated with the consumer provided to the agent device, as described with reference to FIGS. 1 and 2. The verification information may include information indicating whether the authentication of the information was successful or not. At 330, the method 300 includes receiving the verification information indicating a result of the authentication of the information associated with the consumer, and the transaction may be completed or cancelled based on the result of the authentication of the information associated with the consumer. The verification information may be received (e.g., via the network 170) at the third party device from the agent device, or may be received by accessing a database (e.g., the database 130 or the database 150 of FIG. 1).

At 340, the method 300 includes selectively completing the transaction based on the result of the authentication indicated in the verification. For example, when the result of the authentication, as indicated in the verification information, indicates that the authentication was successful (e.g., the information associated with the consumer was authenticated), the transaction may be completed (e.g., a payment may be processed, a product may be shipped, etc.). When the result of the authentication, as indicated in the verification information, indicates that the authentication was not successful (e.g., the information associated with the consumer was not authentic or was invalid), the transaction may be canceled.

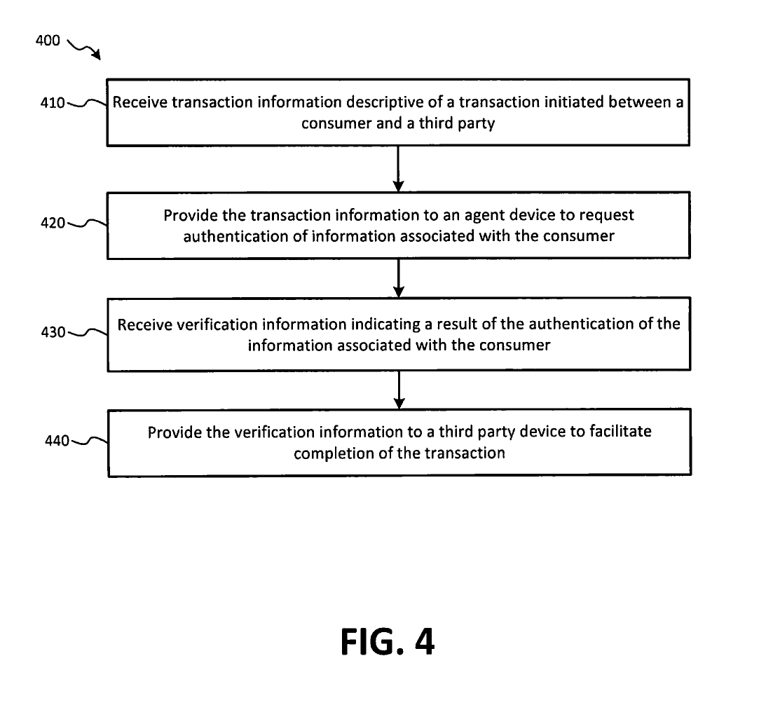

Referring to FIG. 4, a flow chart illustrating aspects of a third exemplary method for authenticating information associated with a consumer in connection with a third party transaction is shown as a method 400. The operations described in connection with the method 400 may be performed by the mobile device 110 of FIG. 1, or any other device configured to perform at least some of the operations described with reference to FIG. 1 with respect to the mobile device 110.

At 410, the method includes receiving transaction information descriptive of a transaction initiated between a consumer and a third party. The transaction information may be the transaction information described with reference to FIG. 1. The consumer may be the consumer 102 of FIG. 1 and the third party may be any one of the exemplary third parties described with reference to FIG. 1, including another consumer. The transaction may be a consumer-to-business transaction or the transaction may be a consumer-to-consumer transaction, as described with reference to FIG. 1. At 420, the method 400 includes providing the transaction information to an agent device to request authentication of information associated with the consumer. The agent device may be the agent device 120 of FIG. 1. Providing the transaction information to the agent device may include presenting information (e.g., a barcode, a transaction identifier, etc.) at a display device of the mobile device, and an input may be provided to the agent device based on the information (e.g., using the I/O devices 138 of FIG. 1, such as a barcode scanner, or by entry of the information using a keyboard, etc.).

At 430, the method 400 includes receiving verification information indicating a result of the authentication of the information associated with the consumer. The result of the authentication included in the verification information may indicate whether the authentication of the information was successful or not. In an aspect, the result may be indicated by a verification code. At 440, the method 400 includes providing the verification information to a third party device to facilitate completion of the transaction. Providing the verification information to the third party device may include providing an input to a website presented within a web browser application executing at the mobile device. Alternatively or additionally, a standalone application executing on the mobile device may be used to provide the verification information (e.g., a verification code) to the third party device. For example, the user of the mobile device may receive a receipt generated by the agent device and the receipt may include a verification code. The user may input the verification code into the application, and the application may initiate transmission of the verification code to the third party device. In other aspects, the input provided to the application and/or the website may indicate that the authentication has been completed, and the third party device, in response to receiving the input, may retrieve the verification information from the agent device or a database accessible to the agent device. Other techniques may be used to provide the verification information to the third party device and the techniques described above are provided for purposes of illustration, rather than by way of limitation.

It is appreciated that the above example cases may be implemented separately or in combination. Additionally, it is noted that one or more steps in the example flow charts illustrated with reference to FIGS. 2-4 may be implemented in a differing order or omitted all together. It is noted that the functional blocks, modules and processes illustrated in FIGS. 1-4 may include or utilize processors (e.g., the processors 112, 122, 142 of FIG. 1, respectively), electronics devices (e.g., the mobile device 110, the agent device 120, the third party device 140, and the central server 160 of FIG. 1), hardware devices, electronics components, logical circuits, memories, software codes, firmware codes, etc., or any combination thereof.

Those of skill would further appreciate that the various illustrative logical blocks, modules, circuits, and algorithm steps described in connection with the present disclosure may be implemented as electronic hardware, computer software (e.g., the instructions 116, 126, 146 of FIG. 1, respectively), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system (e.g., the system 100). Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method (e.g., the method 200 of FIG. 2, the method 300 of FIG. 3, and the method 400 of FIG. 4) or algorithm described in connection with the present disclosure may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium may be coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described in connection with FIGS. 1-4 may be implemented in hardware, software, firmware, or any combination thereof. When implemented in software, the functions may be stored on or transmitted over as one or more instructions (e.g., the instructions 116, 136, 156 of FIG. 1, respectively) or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although aspects of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method comprising:
receiving, by an agent device, transaction information descriptive of a transaction initiated between a consumer and a third party;
receiving, by the agent device, an input associated with authentication of information associated with the consumer; and
generating, by the agent device based on the input associated with the authentication of information associated with the consumer, verification information to facilitate completion of the transaction.

2. The method of claim 1, wherein the transaction information includes a type of verification to be performed, and wherein the type of verification to be performed includes an age verification, a signature verification, a photo verification, an account verification, a financial card verification, a proof of residency verification, a biometric verification, or a combination thereof.

3. The method of claim 2, wherein the transaction is associated with a purchase of a product from the third party.

4. The method of claim 3, wherein the purchase of the product is restricted to consumers having an age that satisfies a threshold age, wherein the type of verification to be performed is an age verification, and wherein the input associated with the authentication of the information associated with the consumer indicates whether the consumer has an age that satisfies the threshold age.

5. The method of claim 2, wherein the transaction is associated with the signing of a document.

6. The method of claim 5, wherein the document is a contract, an application for employment, a loan application, a purchase agreement, an application for a financial card, an application for a bank account, an application for or renewal of a government benefit program, or combination thereof.

7. The method of claim 2, wherein the type of verification to be performed is specified by the third party.

8. The method of claim 1, wherein the third party is an online retailer, wherein the transaction is associated with a purchase from the online retailer, and wherein the verification information is selectively provided to the online retailer to complete the purchase.

9. The method of claim 1, wherein the third party is an online retailer, wherein the transaction is associated with a purchase from the online retailer, wherein the verification information is provided to the consumer, and wherein the consumer provides the verification information to the online retailer to complete the purchase.

10. The method of claim 1, initiating transmission of the verification information to a third party device.

11. The method of claim 1, wherein the transaction information is included in a batch transaction processing request associated with a plurality of transactions initiated by one or more consumers, and wherein, for each of the plurality of transactions, corresponding verification information is provided to facilitate completion of each of the plurality of transactions.

12. The method of claim 11, wherein, for each of the plurality of transactions, the batch transaction processing request includes transaction information indicating a type of verification to be performed, wherein the type of verification to be performed includes an age verification, a signature verification, a photo verification, an account verification, a financial card verification, a proof of residency verification, a biometric verification, or a combination thereof, and wherein different transactions of the plurality of transactions may be associated with a different type of verification.

13. An agent device comprising:
a processor; and
a memory coupled to the processor, the memory storing instructions that, when executed by the processor, cause the processor to perform operations including:
receiving transaction information descriptive of a transaction initiated between a consumer and a third party;
receiving an input associated with authentication of information associated with the consumer; and
generating, based on the input associated with the verification of the identity of the consumer, verification information to facilitate completion of the transaction.

14. The agent device of claim 13, wherein, when the input associated with the authentication of the information associated with the consumer indicates a result of the authentication failed, the verification information causes cancellation of the transaction.

15. The agent device of claim 13, the verification information includes information associated with a biometric sample obtained from the consumer.

16. The agent device of claim 15, wherein the biometric sample includes at least one of a facial recognition sample, a fingerprint scan, a retina scan, a speech sample, a palm print, or a combination thereof.

17. The agent device of claim 15, wherein the authentication of the information associated with the consumer includes comparing a first biometric sample obtained from the consumer in connection with the transaction to a second biometric sample previously obtained from the consumer, and wherein the verification information indicates whether the first biometric sample matches the second biometric sample.

18. The agent device of claim 17, wherein the verification information indicates whether the first biometric sample matches the second biometric sample to within a pre-determine tolerance level.

19. The agent device of claim 13, wherein the input includes an electronic signature obtained from the consumer.

20. The agent device of claim 13, wherein the verification of the identity of the consumer includes authenticating an identification card provided by the consumer, wherein the verification information indicates at least one trait of the consumer, and wherein the at least one trait is obtained from the identification card.

21. The agent device of claim 20, wherein the identification card is authenticated by communicating information obtained from the identification card to a government agency.

22. The agent device of claim 20, wherein the verification information includes a scan of the identification card.

23. The agent device of claim 13, wherein the verification information includes an image of the consumer.

24. A computer-readable storage device storing instructions that, when executed by a processor, cause the processor to perform operations comprising:
receiving transaction information descriptive of a transaction initiated between a consumer and a third party;
receiving an input associated with a verification of an identity of the consumer; and
generating, based on the input associated with the verification of the identity of the consumer, verification information to facilitate completion of the transaction.

25. The computer-readable storage device of claim 24, wherein the operations includes determining a type verification to be performed based on the transaction information, wherein the transaction information includes a type of verification to be performed, and wherein the type of verification to be performed includes an age verification, a signature verification, a photo verification, an account verification, a financial card verification, a proof of residency verification, a biometric verification, or a combination thereof.

26. The computer-readable storage device of claim 24, wherein the verification information includes a verification code, and wherein the operations include storing the verification code in a database accessible to the third party.

27. The computer-readable storage device of claim 24, wherein the transaction is associated with a probation check-in, an unemployment verification, an application for a government benefit, a renewal of a government benefit, an application for a government issued identification card, an application for a government issued license, an application to register to vote, or a combination thereof.

28. The computer-readable storage device of claim 24, wherein the third party is a banking entity, and wherein the transaction is associated with a deposit into an account at the banking entity.

29. The computer-readable storage device of claim 24, wherein the transaction is associated with execution of a legal document, execution of a purchase agreement, an application for employment, an application for insurance, filing of an insurance claim, a loan application, a transfer of title, a contract, an application to open a bank account, an application to open a credit card.
